(19) United States
(12) Patent Application Publication
(10) Pub. No.: US 2009/0214829 A1
(43) Pub. Date: Aug. 27, 2009

(54) Method of Applying a Decorative Film to a Support and Method of Preparing Articles for Said Purpose

(76) Inventor: Stanislas Chevallier, La Celle Saint-Cloud (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/884,043

(22) PCT Filed: Feb. 8, 2006
(86) PCT No.: PCT/EP06/50774

§ 371 Date: Nov. 10, 2008

(30) Foreign Application Priority Data
Feb. 8, 2005 (FR) 0501273

(51) Int. Cl. B32B 3/02; B44C 1/175; B32B 38/14

(52) U.S. Cl. 428/157; 156/235; 156/277; 427/372.2

(57) ABSTRACT

The invention relates to a method of applying a decorative film to a support and methods of preparing articles for said purpose. The inventive method comprises the following steps consisting in: (a) obtaining a first support that can receive a material to be painted having limited adhesion strength; (b) applying the material to be painted such as to form a film; (c) drying the film; (d) applying a water-deactivatable adhesive to the film; (e) applying a second partially-absorbent, deformable support against the film such that it is contact with same; (f) peeling the assembly formed by the second support and the film affixed thereto; (g) applying another adhesive to a definitive support and/or the free face of the film; (h) applying the second film-equipped support against the definitive support; and (i) peeling the temporary second support such as to leave the film on the definitive support, the first adhesive being sufficiently weak for same.

The present invention generally relates to techniques for transposition or transfer of decorative layers.

Numerous techniques for transposing a decorative layer by dry or wet method are already known.

Classically, the wet method is the technique of coloured paper or sticker transfer, while the dry method involves using a layer of adhesive sensitive to pressure, preserved until used by a peelable film.

In general, these known techniques involve the decorative layer itself being on a support having a certain thickness, the general effect of which is to stick down the unevenness of the surface receiving the decorative layer. Also, these techniques involve the appearance of the decorative layer being defined in advance, in general without the possibility of making overdimension decorations.

The aim of the present invention is to propose a novel technique for transposition of decorative layer which both gives a result which can be visually similar to that obtained by a conventional painting technique, and which also can be implemented economically, simply and unobtrusively.

To this end the invention proposes according to a first aspect a process for application of a decorative film on a support, characterised in that it comprises the following steps:

(a) providing a first temporary support having surface characteristics such as a material to be painted can be applied in the form of a film directly onto said temporary support, while generating limited adhesion strength between the temporary support and the film;

(b) applying said material to be painted on said support to form the film;

(c) drying the film;

(d) applying to the film a first adhesive, deactivatable in water;

(e) applying a second thin temporary support with high deformability capacity and partially absorbent against the film present on the first temporary support and fitted with the first adhesive, so as to place it in contact over their entire common extent, this first adhesive being suitable for generating adhesion forces greater than those existing between the film and the first temporary support between the film and said second temporary support;

(f) after adequate drying of the first adhesive, exerting traction on the second temporary support so as to peel off an assembly formed by said second temporary support and said film of material to be painted, held together by said first adhesive;

(g) applying a second adhesive to a definitive support and/or to the free face of the film held on the second temporary support;

(h) applying the second temporary support fitted with the film against said definitive support;

(i) after adequate drying of the second adhesive, peeling the second temporary support while leaving the film of material to be painted on the definitive support, the activity of the first adhesive being sufficiently low to enable this peeling.

High deformability with respect to the second support is understood to mean the capacity to easily be moved away from its plane, but a weak aptitude in being deformed in its plan.

Certain preferred though non-limiting aspects of this process are the following:
the process also comprises an adjustment step of the surface activity of the first temporary support by application of a surfactant product.
the first temporary support is a plate of glass or synthetic material or a supple film made of synthetic material.
the material to be painted is an acrylic paint.
the second temporary support is a cloth, in particular a cotton cloth.
step (b) is implemented by means of a painting machine.
the process also comprises, between steps (c) and (d), a step consisting of printing on the film of material to be painted.
said printing step is implemented by means of an ink jet unit and with ink for impregnating the film at least partially.
the process comprises a specific step of lowering the activity of the first adhesive by applying water to the exposed face of the second temporary support, opposite the film, this water passing through said second temporary support to reach the first adhesive.

According to a second aspect, the present invention proposes a process for application of a decorative film to a support, characterised in that it comprises the following steps:

(a) providing a temporary support having surface characteristics such as a material to be painted can be applied in the form of a film directly to said temporary support, while generating limited adhesion strength between the temporary support and the film;

(b) applying said material to be painted on said support;

(c) drying the film;

(d) applying to a definitive support and/or to the free face of the film an adhesive for generating adhesion forces greater than those existing between the film and the temporary support between the film and the definitive support;

(e) applying the temporary support fitted with the film against said support; and

(f) after adequate drying of said adhesive, peeling the temporary support in leaving the film of material to be painted on the definitive support.

Certain preferred though non-limiting aspects of this process are the following:
the process also comprises an adjustment step of the surface activity of the temporary support by application of a surfactant product.
the temporary support is a supple film made of synthetic material.
the material to be painted is an acrylic paint.
the step (b) is implemented by means of a painting machine.
the process also comprises, between steps (c) and (d), a step consisting of printing on the film of material to be painted.
said printing step is implemented by means of an ink jet unit and with an ink for impregnating the film at least partially.
the material to be painted is barely or not loaded with pigments.

According to a third aspect of the invention a process for manufacturing an article is proposed, especially allowing affixing a decorative film on a support, characterised in that it comprises the following steps:

(a) providing a first temporary support having surface characteristics such as a material to be painted can be applied in the form of a film directly to said temporary support, while generating limited adhesion strength between the temporary support and the film;

(b) applying said material to be painted to said support to form the film;

(c) drying the film;

(d) applying to the film a first adhesive, deactivatable in water;

(e) applying a second thin temporary support with high deformability capacity and partially absorbent against the film present on the first temporary support and fitted with the first adhesive, so as to place it in contact over their entire common extent, this first adhesive being suitable for generating adhesion forces greater than those existing between the film and the first temporary support between the film and said second temporary support; and

(f) after adequate drying of the first adhesive, exerting traction on the second temporary support so as to peel off an assembly formed by said second temporary support and said film of material to be painted, held together by said first adhesive.

High deformability with respect to the second support is understood to mean the capacity to easily be moved away from its plane, but low aptitude for deforming in its plane.

A process for manufacturing an article especially allowing tile affixing of a decorative film on a support is also proposed, characterised in that it comprises the following steps:

(a) providing a temporary support having surface characteristics such as a material to be painted can be applied in the form of a film directly to said temporary support, while generating limited adhesion strength between the temporary support and the film;

(b) applying said material to be painted to said support; and

(c) drying the film.

According to yet another aspect, according to the invention an article for affixing a decorative film to a support is provided, prepared especially by a process such as defined hereinabove, characterised in that it is in the form of a width comprising a main zone with a film of painted material containing pigments and two zones of edge width essentially constant with a reduced density of pigments and/or a reduced thickness of product to be painted relative to the main zone.

Finally, a process for preparation of an article enabling transposition of a decoration made by printing machine on a support is provided, characterised in that it comprises steps consisting of:

(a) applying a film of material to be painted directly to a support, said film being selected to be capable of entering a printing machine; and

(b) directly applying the dry film of material to be painted held on the support in said printing machine.

Advantageously, the support is selected from supple films made of synthetic material and cloths.

According to another preference, the support is a supple film coated with an adhesive protected by a peelable film.

Other aspects, aims and advantages of the present invention will emerge from the following detailed description of preferred embodiments of the latter, given by way of non-limiting example and in reference to the attached diagrams, in which:

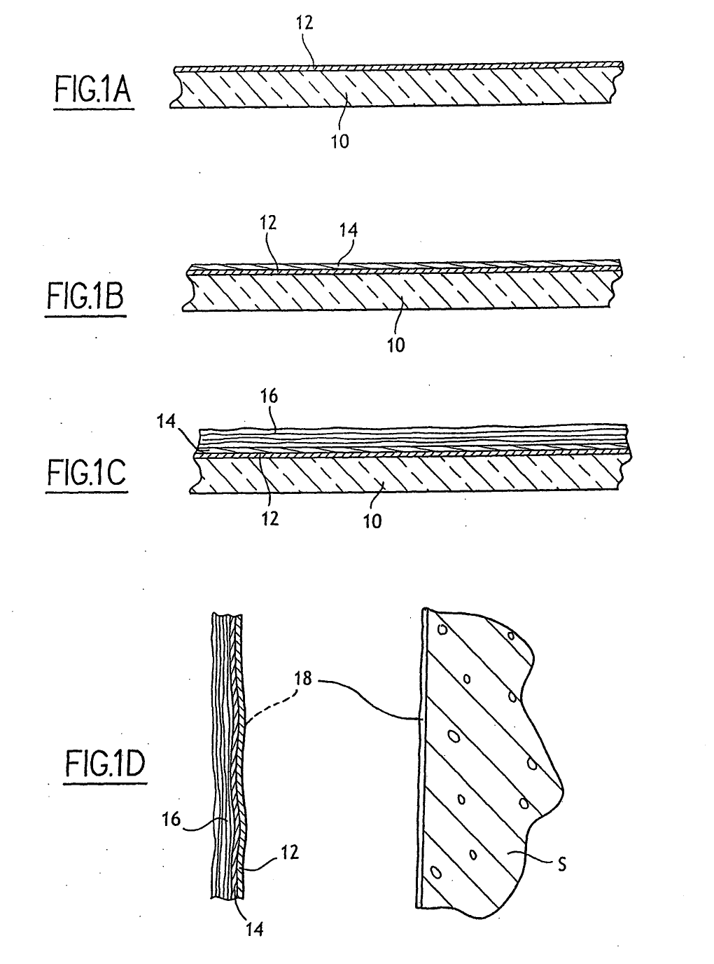

FIGS. 1A to 1F illustrate different steps of a process for transposition of decorative layer according to a first embodiment of the invention,

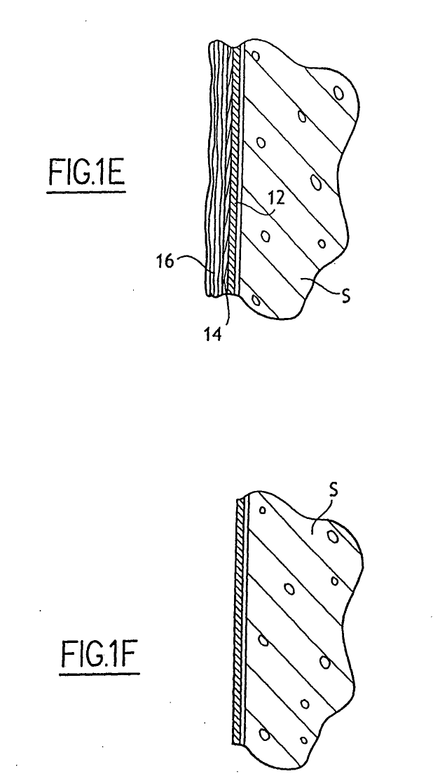

FIGS. 2A to 2C illustrate different steps of a process for transposition of a decorative layer according to a second embodiment of the invention,

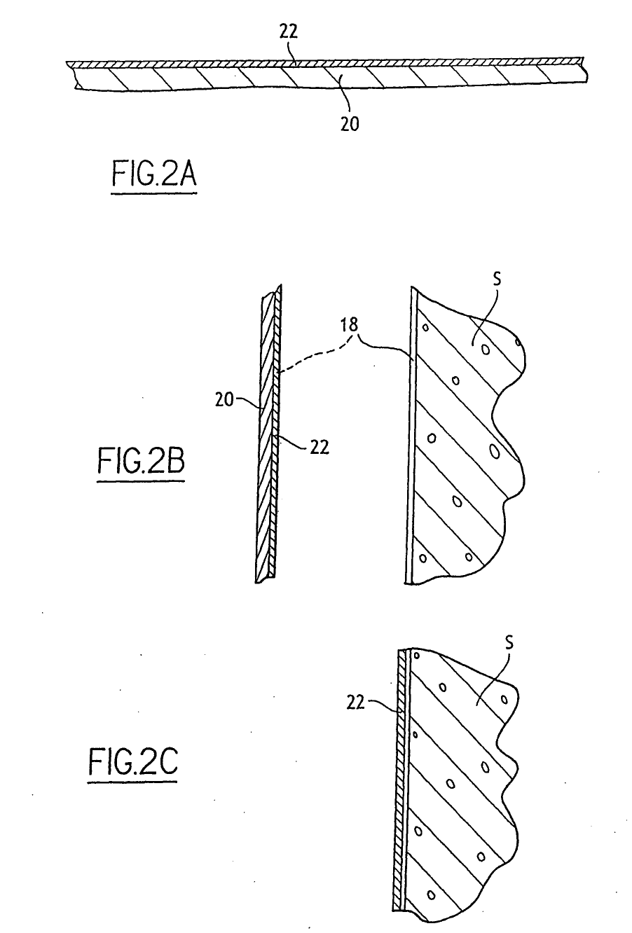

FIG. 3 is a frontal view of a width according to a variant embodiment of the invention,

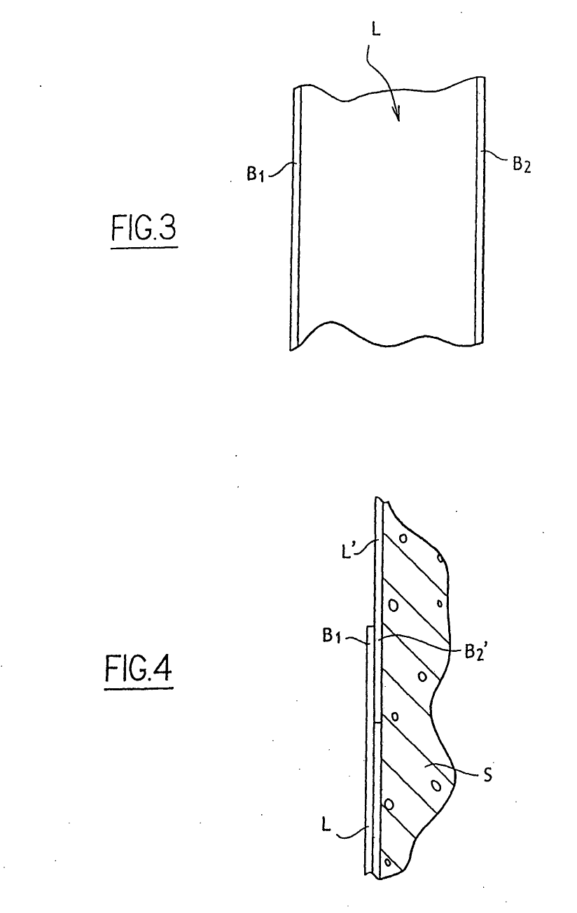

FIG. 4 is a sectional view of the region where two adjacent widths each realised according to FIG. 3 are joined, and

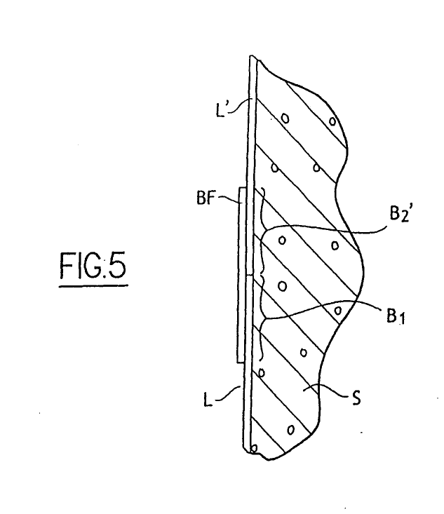

FIG. 5 is a sectional view of the region where two adjacent widths each realised according to FIG. 3 are joined, in a variant embodiment.

In reference first of all to FIGS. 1A to 1F, a process according to a first embodiment of the invention will now be described.

First of all, a first temporary smooth support 10 having properties of weak adherence is provided. This support can be rigid or supple. It is a plate of glass or a film of synthetic material (PVC, polycarbonate, polyamide, etc.) for example.

The surface activity of this temporary support is determined such that a paint can be applied to a face thereof. If necessary, this surface preparation can be done simply by cleaning the surface with a surfactant product.

One or more coats 12 of a product to be painted (FIG. 1A) is then applied to this surface. Typically, this product to be painted is a commercially available paint, preferably a paint based on aqueous solvent such as an acrylic paint. In conventional terms per so, during application with several coats there is a period of adequate drying of the applied coat before the next coat is applied.

Any appropriate application mode can be selected, especially via brush, roller or pistol.

In the case of a uniform acrylic paint, the average thickness of the paint coat is preferably between around 5 and 20 μm (dry).

In certain cases however multiple coats of paint can be applied in order to achieve much greater thicknesses, for example around 100 μm, especially in the event where irregularities in the definitive support are to be attenuated.

Complete drying of the resulting paint film 12 occurs either naturally, or by applying heat in an oven, under an infrared lamp, etc.

The following step (FIG. 1B) consists of applying a thin layer 14 of an adhesive in the liquid or viscous state and soluble in water to the free face of the paint film 12. A natural adhesive (based on starch, gum Arabic, etc.) or synthetic adhesive (methyl cellulose-based adhesive, etc.) can especially be selected.

It was likewise observed in carrying out assays that an adhesive, in principle non soluble to water after drying, and in particular a vinyl adhesive, could well be suitable, as will be seen hereinbelow.

Before this adhesive 14 is dried, a second temporary support 16 is applied to the free face of the resulting whole, on the adhesive 14 side, (FIG. 1C). This temporary support is selected to partially absorb the adhesive layer 14 and exhibit high deformability. Typically, a cotton or synthetic cloth, or even a non-woven material is selected for this support.

By way of indication, a cotton cloth of gsm of the order of 100 g/m² can be used.

This second support 16 is pressed onto the support 10 provided with the paint film 12 and the adhesive layer 14 over its entire area, to create a mechanical bond between the fibres of the fabric and the adhesive.

At the earliest after a dwell time of a few minutes to several tens of minutes (duration to be adjusted in particular according to the water content of the adhesive), traction is exerted to the fabric 16, starting with one edge and moving away from the plane of the plate 10, after which separation is observed between the paint film 12 and said plate 10, whereof the adhesive forces are much lower than those existing between said film 12 and the fabric 16 by means of the adhesive layer 14. This separation takes place completely continuously and without deterioration of the coat of paint; on completion of this operation the result is an assembly constituted by the fabric support 16, the adhesive layer 14 and the paint film, not altered (absence of cracks, flaking or zones where paint is missing).

The applicant also observed that the temperature could have an influence on the separation operation described hereinabove. In particular, in the event where the support 10 is a supple film made of synthetic material, heating it to a range of temperatures preferably of the order of 70 to 90° C. facilitates separation quality. This application of heat can be done for example using a source of hot air sweeping the back of the support 10.

The assembly obtained after separation is illustrated to the left of FIG. 1D. This product can be prepared for example in widths for commercial use and applied by the individual or the professional.

The application operation will now be described with reference to FIGS. 1D to 1F.

First of all, an adhesive in liquid or viscous form, and preferably a natural adhesive based on hydrosoluble starch, an adhesive based on methyl cellulose, a vinyl adhesive (for example of the Flexiadhesive type—registered trade mark) or an acrylic adhesive or again paint binder (for example of Bindex or Caparol type—registered trade marks) or matte varnish (for example acrylic varnish of Polyvine type—registered trade mark), is applied either to the face of a definitive support S to be decorated, or to the free face of the paint film 12, or again to both.

The width is then applied against the support S. Masking by brush or any other instrument can be done where required to ensure uniform contact of the paint film and of the support S over the entire extent of the width (FIG. 1E).

After drying of the adhesive (variable according to the nature of the adhesive utilised), the exposed face (back) of the fabric support 16 is humidified by applying water, for example using a sponge. The effect of this is to dissolve the adhesive 14 binding the fabric 16 to the paint film 12 by the water having passed through the fabric.

Traction is then progressively exerted in variable directions, but which remain adjacent to its plane, on the fabric 16, to completely separate the former from the paint film, which stays fixed on the support S.

The fabric 16 can then be discarded, or recycled.

The result on the support S is a paint film whereof the appearance is very similar to that of traditionally made paint.

The last step consists of eliminating, for example by means of a sponge, traces of the adhesive layer 14 remaining on the paint film 12.

With respect to using a vinyl adhesive, it has been noticed unexpectedly that a highly satisfactory result could be arrived at with this type of adhesive, to the extent where application of water to the back of the fabric 16 helps decrease its adhesive strength to the point of enabling separation of the film relative to the fabric, and likewise to the extent where traces of adhesive remaining on the film 12 once fixed to the definitive support S can easily be removed by wet sponge.

It will be noted here that, according to the nature of the adhesive used, the step of decreasing activity by applying water cannot be necessary. In particular, it proves that certain mechanical stresses exerted on the fabric/paint film assembly (for example during use of a roller and/or masking carried out during application to the definitive support) created a sufficient drop in activity of this adhesive. It is also possible that applying water does not cause dissolution of the adhesive, rather swelling of the fabric which lowers the activity of the adhesive here again mechanically.

It will be noted here that by playing on the nature of the material to be painted and on the thickness of the resulting layers, the structure of the support can be left visible (for example paint on wood) or on the contrary a smoother rendering can be obtained, where the irregularities of the support are gummed to a certain extent.

In addition, the considerable deformability of the woven support 16 allows the paint film to be applied to curved, angled surfaces, etc. (for example mouldings, cornices, etc.) due to its aptitude to adopt this type of surface.

The process described according to the invention can be utilised to apply plain decorative layers, or patterned layers, multicoloured works, etc.). The application of paint can be done either manually (especially for original work), or by means of a commercial painting machine.

In this respect, the result obtained on the final support S is identical to what was achieved on the primary support 10, including what relates to any possible reliefs (excesses of material, etc.) intended during this realisation. The process can thus be employed to make any original painting, frescos, etc., these first being made on the primary support 10 then transposed, identically, to the definitive support.

It will also be noted that the novel product constituted by the fabric 16 on which the paint film 12 adheres via the layer of adhesive 14 has an original appearance and can be utilised for purposes other than decoration of surfaces, and especially in the field of clothing (clothes), interior decoration (fabrics, curtains, . . . ), etc. If necessary, the nature of the adhesive 14 utilise is adapted to obtain the desired qualities Of solidity and resistance.

With reference to FIGS. 2A to 2D a second embodiment of the invention will now be described.

According to this one or more layers of paint 22 are applied to an intermediate support 20 constituted by a supple film with reduced adherence, typically made of synthetic material.

After application this support 20 is sufficiently supple to be able to be rolled up. Typically, a film of PVC having a thickness of preferably between around 50 and 300 μm is used.

If necessary, and in the same way as in the preceding embodiment, the surface of the support 20 is activated in a controlled manner by means of a surfactant so as to be able to apply to it the material to be painted.

The latter is here again, preferably, based on acrylic resins and any desired application technique and number of layers is used. As before, this can be plain application, or with patterns, or even ‘an artistic work’.

This second embodiment directly creates the commercial product, however with greater restrictions in application material since the support 20 must be sufficiently solid to be able to receive all application of paint without compromising its dimensional stability, and thus be less disposed than the fabric 16 of the preceding embodiment to adopt any curves, slope breaks or even notch formations or reliefs, of the final support S.

The placing of widths obtained as hereinabove is illustrated in FIGS. 2B and 2C. A natural or synthetic adhesive 18 is applied to the support S and/or the tree face of the paint film 22 adhering to its support 20, and the width is then applied firmly against said support so as to make full contact of the film 22 with the latter.

After drying of the adhesive layer 18, the support 20 is delicately detached, the paint film remaining on the support due to substantially stronger adhesion on the latter made by means of said adhesive.

The support 20 can easily be recycled.

It will be evident here that this second process carries out inverse transposition, and that it is necessary to remember this in the event where works of artistic character or those giving information (signs, . . . ) are made on the support 20.

It will be evident here that, just as much in the first as in the second embodiment, the preparation steps of the widths before transposition can be carried out manually or automatically on a large-scale manufacturing chain.

With reference to FIGS. 3 and 4 an improvement of the present invention will now be described, in the event where it is implemented in the form of plain or substantially plain widths to be placed side by side (similarly to placing painted paper).

In this case the problem actually arises of the connection between two adjacent widths, requiring particular care.

To decrease the inaesthetic visual effects in the event where the connection between two widths is not perfect, there is provision according to this improvement to make each width L by providing two edge zones B1 and B2 known as reduction bands, where the quantity or density of paint is reduced and preferably substantially divided by two. This is obtained for example:
by applying in these edge zones one or more layers of paint less than in the main central zone of the width (for example two layers instead of four);
or by applying in these zones a paint less rich in pigments than in the central zone;
or again a combination of these two approaches. These bands B1 and B2 preferably have a width of between around 3 and 15 mm, and plus preferably between 5 and 7 mm.

In this way, as the two widths are placed, and in ensuring as good a covering as possible between the edge zone B1 of one of the widths and the adjacent edge zone B2′ of the other width L′, the visual effects associated with offsetting between the widths are attenuated, since in every case the support (often a very light or white colour) will not appear, and the differences in terms of colour intensity in this region will be attenuated.

As a variant, it can also be ensured that the quantity or density of paint progressively diminishes from the main central zone of the width when arriving at its two edge zones B1 and B2.

In any case, it can be advantageous that the temporary support on which the film is held prior to application on the definitive support is provided with marginal support bands separable at the edge zones B1 and B2. In such case, a first width can be set, the marginal support band situated to one side can be removed to disengage the corresponding edge zone, the following width with the desired covering can be placed between adjacent edge zones, and so on, and the main parts of the temporary supports are then all withdrawn at the same time by wetting and dissolving the adhesive.

According to another variant, the temporary supports can be provided with all marks or markings for placing the adjacent widths with the desired covering.

According to another variant again, and in reference to FIG. 5, it can be ensured to stick widths with edge zones such as described above not with covering but edge to edge. Next, there is overlapping of each pair of adjacent widths a finishing band BF, preferably according to the application process of the present invention, whereof the width is substantially equal to the cumulative widths of the two adjacent edge zones B1 and B2′. This BF band has substantially the same quantity or density of material to be painted as the edge zones B1 and B2′, so much so that after application of the latter visual perception of the transition between two widths is substantially attenuated.

Another improvement of the processes according to the present invention will now be described, with the aim of applying decorative films of any desired appearance to a support by utilising modern digital printing techniques.

More precisely, according to this improvement, the film of material to be painted acts as a support to printing, typically ink jet or bubble jet printing, which can be done using a conventional printer or plotter.

Advantageously, the inks and the material to be painted used are such that said inks impregnate said material to be painted which, after drying, takes up such printing. This impregnation can be more or less pronounced as a function of application.

Printing which can be very fine and according Lo all patterns stored in a data-processing station is completed, and at the same time highly resistant due to the phenomenon of the abovementioned impregnation.

In a preferred example, printing was done with an ink jet printer with piezoelectric heads using solvent inks. For example, a Seiko ColorPainter 64S printer model for large-size supports can be utilised. The paint is preferably an acrylic paint.

In the case of process according to the first embodiment of the invention (identical transposition), the printing is done on the paint film 12 previously applied to the first temporary support 10, and a sufficiently thin supple film (for example a film of PVC of the order of 100 μm thick is selected for this.

As a variant, a colourless material to be painted (translucid) or a tinted paint can be used, as a function of the desired visual effect.

The following steps of the process are then implemented, after adequate dwell time so that the printing ink can have dried.

It will be noted here that, in a measure compatible with the printing equipment being used, the film 12 receiving said printing can be given an uneven thickness to create a rendering with a certain relief.

In the case of the process according to the second embodiment of the invention, printing is done on the face of the film 22 of paint which will be applied against the final support S. It is thus necessary, for the printing to be visible after application, to use a transparent material to be painted, or in any case barely loaded with pigments. In addition, due to the fact that the carryover occurs with inversion of what is done on the primary support 20, printing is carried out with corresponding inversion.

Another aspect of the invention aimed at applying printing of excellent quality to varied supports using the abovementioned modern printing techniques will now be described.

More precisely, this aspect of the invention is based on the fact that a film of material to be painted, preferably done with acrylic paint, proves to constitute an excellent support for such printing by opposition to certain traditional supple supports available commercially.

As shown above, here again the inks and the material to be painted can be selected so a to control the degree of impregnation of the film of material to be painted with the inks and the overall rendering, resulting in printing which can be very fine and highly resistant due to the phenomenon of the abovementioned impregnation.

In a preferred example, the printing was done using a Seiko ColorPainter 64S or 100S ink jet printer.

The acrylic paint film can be applied to a support whereof the nature can be extremely varied: supple film made of synthetic material, cloth impregnated or not (for example linen cloth to be later attached to a frame), the essential restriction being that this support can be accepted by the printing equipment.

The material to be painted will be white if the printing colours are to be respected, or colourless (translucid) or tinted, as a function of the desired visual effect.

Here again, the film receiving said printing can be given a non-uniform thickness to create a rendering with a certain relief.

The product making up the layer support and the paint film on which the printing has been done can be utilised as such in different ways, and for example fixed in its assembly to any definitive support. To this effect, the support layer can be coated on the side opposite the paint film with an adhesive protected temporarily by a peelable film, for easy fixing of the assembly.

In its first aspects, the invention includes the possibilities of application of decorative films, for both industrial and domestic usage. Since the paint is transferred dry, the problems of odour, edge formation and uneven applications are resolved, including on non-flat surfaces (cornices, mouldings, etc.). No time waiting for paint to dry is required. No emanation of glycol (health . . . ).

In its last aspect, it extends to possibilities for using modern digital printing techniques, such as ink jet.

It is understood that numerous variants and modifications can be made to the invention, and, from the indications of the above description, the specialist will know how to use any composition appropriate for supports, materials to be painted, layers of adhesion, etc.

1. A process for application of a decorative film on a support, characterised in that it comprises the following steps:
(a) providing a first temporary support having surface characteristics such as a material to be painted can be applied in the form of a film directly onto said temporary support, while generating limited adhesion strength between the temporary support and the film;
(b) applying said material to be painted on said support to form the film;
(c) drying the film;
(d) applying to the film a first adhesive, deactivatable in water;
(e) applying a second thin temporary support with high deformability capacity and partially absorbent against the film present on the first temporary support and fitted with the first adhesive, so as to place it in contact over their entire common extent, this first adhesive being suitable for generating adhesion forces greater than those existing between the film and the first temporary support between the film and said second temporary support;
(f) after adequate drying of the first adhesive, exerting traction on the second temporary support so as to peel off an assembly formed by said second temporary support and said film of material Lo be painted, held together by said first adhesive;
(g) applying a second adhesive to a definitive support and/or to the free face of the film held on the second temporary support;
(h) applying the second temporary support fitted with the film against said definitive support;
(i) after adequate drying of the second adhesive, peeling the second temporary support while leaving the film of material to be painted on the definitive support, the activity of the first adhesive being sufficiently low to enable this peeling.

2. The process as claimed in claim 1, characterised in that it further comprises an adjustment step of the surface activity of the first temporary support by application of a surfactant product.

3. The process as claimed in claim 1 or 2, characterised in that the first temporary support is a plate of glass or synthetic material or a supple film made of synthetic material.

4. The process as claimed in any one of claims 1 to 3, characterised in that the material to be painted is an acrylic paint.

5. The process as claimed in any one of claims 1 to 4, characterised in that the second temporary support is a cloth, in particular a cotton cloth.

6. The process as claimed in any one of claims 1 to 5, characterised in that the step (b) is implemented by means of a painting machine.

7. The process as claimed in any one of claims 1 to 6, characterised in that it further comprises, between steps (c) and (d), a step consisting of printing on the film of material to be painted.

8. The process as claimed in claim 7, characterised in that said printing step is implemented by means of an ink jet unit and with an ink for impregnating the film at least partially.

9. The process as claimed in any one of claims 1 to 8, characterised in that it comprises a specific step for lowering the activity of the first adhesive by applying water on the exposed face of the second temporary support, opposite the film, this water passing through said second temporary support to reach the first adhesive.

10. An application process of a decorative film on a support, characterised in that it comprises the following steps:
(a) providing a temporary support having surface characteristics such as a material to be painted can be applied in the form of a film directly onto said temporary support, while generating limited adhesion forces between the temporary support and the film;
(b) applying said material to be painted on said support;
(c) drying the film;
(d) applying to a definitive support and/or on the free face of the film an adhesive for generating between the film and the definitive support adhesion forces greater than those existing between the film and the temporary support;
(e) applying the temporary support fitted with the film to said support; and
(f) after adequate drying of said adhesive, peeling the temporary support while leaving the film of material to be painted on the definitive support.

11. The process as claimed in claim 10, characterised in that it further comprises an adjustment step of the surface activity of the temporary support by application of a surfactant product.

12. The process as claimed in claim 10 or 11, characterised in that the temporary support is a supple film made of synthetic material.

13. The process as claimed in any one of claims 10 to 12, characterised in that the material to be painted is an acrylic paint.

14. The process as claimed in any one of claims 10 to 13, characterised in that the step (b) is implemented by means of a painting machine.

15. The process as claimed in any one of claims 10 to 14, characterised in that it further comprises, between steps (c) and (d), a step consisting of printing on the film of material to be painted.

16. The process as claimed in claim 15, characterised in that said printing step is implemented by means of an ink jet unit and with an ink suitable for impregnating the film at least partially.

17. The process as claimed in any one of claims 14 to 16, characterised in that the material to be painted is barely or not loaded with pigments.

18. A process for manufacturing an article especially allowing the affixing of a decorative film on a support, characterised in that it comprises the following steps:
(a) providing a first temporary support having surface characteristics such as a material to be painted can be applied in the form of a film directly to said temporary support, while generating limited adhesion strength between the temporary support and the film;
(b) applying said material to be painted on said support to form the film;
(c) drying the film;
(d) applying to the film a first adhesive, deactivatable in water;
(e) applying a second temporary thin support with high deformability and partially absorbent against the film present on the first temporary support and fitted with the first adhesive, so as to place it in contact over their entire common extent, this first adhesive being suitable for generating between the film and said second temporary support adhesion forces greater than those existing between the film and the first temporary support; and
(f) after adequate drying of the first adhesive, exerting traction on the second temporary support so a to peel an assembly formed by said second temporary support and said film of material to be painted, held together by said first adhesive.

19. The process as claimed in claim 18, characterised in that it further comprises an adjustment step of the surface activity of the first temporary support by application of a surfactant product.

20. The process as claimed in claim 18 or 19, characterised in that the first temporary support is a plate of glass or synthetic material or a supple film made of synthetic material.

21. The process as claimed in any one of claims 18 to 20, characterised in that the material to be painted is an acrylic paint.

22. The process as claimed in any one of claims 18 to 21, characterised in that the second temporary support is cloth, in particular cotton cloth.

23. The process as claimed in any one of claims 18 to 22, characterised in that the step (b) is implemented by means of a painting machine.

24. The process as claimed in any one of claims 18 to 23, characterised in that it further comprises, between steps (c) and (d), a step consisting of printing on the film of material to be painted.

25. The process as claimed in claim 24, characterised in that said printing step is implemented by means of an ink jet unit and with an ink for impregnating the film at least partially.

26. A process for manufacturing an article especially allowing affixing of a decorative film on a support, characterised in that it comprises the following steps:
(a) providing a temporary support having surface characteristics such as a material to be painted can be applied in the form of a film directly to said temporary support, while generating limited adhesion strength between the temporary support and the film;
(b) applying said material to be painted to said support; and
(c) drying the film.

27. The process as claimed in claim 26, characterised in that it further comprises an adjustment step of the surface activity of the temporary support by application of a surfactant product.

28. The process as claimed in claim 26 or 27, characterised in that the temporary support is a supple film made of synthetic material.

29. The process as claimed in any one of claims 26 to 28, characterised in that the material to be painted is an acrylic paint.

30. The process as claimed in any one of claims 26 to 29, characterised in that the step (b) is implemented by means of a painting machine.

31. The process as claimed in any one of claims 26 to 30, characterised in that it further comprises, between steps (c) and (d), a step consisting of printing on the film of material to be painted.

32. The process as claimed in claim 31, characterised in that said printing step is implemented by means of an ink jet unit and with an ink for impregnating the film at least partially.

33. The process as claimed in claim 31 or 32, characterised in that the material to be painted is barely or not loaded with pigments.

34. An article for affixing a decorative film on a support, prepared especially by the process as claimed in any one of claims 18 to 33, characterised in that is in the form of a width comprising a main zone with a film of painted material containing pigments, and two zones of edge width essentially constant with a reduced density of pigments and/or a reduced thickness of product to be painted relative to the main zone.

35. A process for preparation of an article allowing transposition of a decoration done by printing machine on a support, characterised in that it comprises steps consisting of:
(a) applying a film of material to be painted directly to a support, said film being selected to be capable of entering a printing machine; and
(b) directly printing the dry film of material to be painted held on the support in said printing machine.

36. The process as claimed in claim 35, characterised in that the support is selected from supple films made of synthetic material and cloth.

37. The process as claimed in claim 35 or 36, characterised in that the support is a supple film coaled with an adhesive protected by a peelable film.
